(19) United States
(12) Patent Application Publication
(10) Pub. No.: US 2007/0196003 A1
(43) Pub. Date: Aug. 23, 2007

(54) Optical finger print input device

(76) Inventors: Hyun Kim, Gyeonggi-do (KR); Young Jin Seo, Seuol (KR); Jong Woo Ahn, Seoul (KR); Seung Min Lee, Seoul (KR); Sa Hyang Hong, Seoul (KR); Tae Hun Lee, Gyeonggi-do (KR); Byung Kee Kwak, Metropolitan City (KR)

Correspondence Address: John W Wenner;Renner Otto Boisselle & Sklar, 1621 Euclid Avenue, Nineteenth Floor, Cleveland, OH, 44115, US

(21) Appl. No.: 10/593,373

(22) PCT Filed: Sep. 14, 2004
(86) PCT No.: PCT/KR04/02328

§ 371 Date: Sep. 19, 2006

(30) Foreign Application Priority Data
Mar. 29, 2004 (KR) 10-2004-0021162

(51) Int. Cl. G06K 9/00

(52) U.S. Cl. 382/127

(57) ABSTRACT

An optical fingerprint input device by where a mark identification is attached to one surface of a prism and reflected by light beams coming from an external light source to be incident on a lens such that erroneous recognition caused by a fingerprint afterimage of water, sweat or oil remaining on the fingerprint contact surface of the prism can be prevented to improve the security of the device, and a visual advertisement can be additionally obtained when a mark identification logo for advertisement is attached on one surface of the prism.

### FIELD OF THE INVENTION

The present invention relates to an optical fingerprint input device and, more particularly, to an optical fingerprint input device adapted to prevent a natural erroneous recognition generated by an afterimage remaining on a fingerprint contact surface following a fingerprint recognition and an erroneous recognition generated by artificially using a fingerprint afterimage, thereby increasing the security of the device.

### BACKGROUND OF THE INVENTION

Generally, if a fingerprint smeared with sweat or oil is imprinted in an optical fingerprint input device, an afterimage is generated on a fingerprint contact surface, and this afterimage functions as distortion when the next fingerprint is taken. Meanwhile, the afterimage can be recognized as a fingerprint by an external light source or an internal light source even though a finger has not been contacted on the fingerprint contact surface.

In order to overcome the aforementioned drawback, the present applicant filed a patent application relating to an optical fingerprint input device on Feb. 2, 2001 under Korean Patent Application No. 2001-0005036, and was registered on Mar. 5, 2004 as Korean Patent No. 453255.

The optical fingerprint input device filed by the present applicant and registered by the Korean Intellectual Property Office includes, as illustrated in FIG. 1, a light source (1), a prism (2), a lens (3) and an image sensor (4). An inclination as large as an established angle (α) is formed by a perpendicular line (PL) connecting to a corner (2-1) vertically positioned from a surface (2a) contacting a fingerprint region of the prism (2) and an incident path of a light (OA, hereinafter referred to as optical axis) which travels from the prism (2) to the lens (3) and image sensor (4).

Under this circumstance, even though sweat or oil is smeared on a fingerprint contact surface, only actual fingerprint images are accepted such that an erroneous recognition caused by an overlap of the afterimage with the actual fingerprint image can be prevented.

An operational principle of prevention of overlap will now be explained briefly below.

Referring to FIG. 2, a light beam is refracted and advances along a first light path (1) when a refractive index of a medium on which the light beam is incident is larger than that of a medium through which the light beam penetrates. However, when an incident angle (θᵢ) exceeds a certain degree, no light beams penetrate through outside the medium, the phenomenon of which is referred to as total internal reflection and the angle under this circumstance is referred to as critical angle which is determined by refractive indexes of two media comprising a boundary surface therebetween.

The critical angle is an incident angle (θᵢ) when θₜ is 90 degrees, and can be applied according to Snell's law provided in Formula 1.

### <FORMULA 1>

nᵢ sin θᵢ=nₜ sin θₜ: Snell's law
where nᵢ is a refractive index of an incident medium, nₜ is a refractive index of penetrated medium, θᵢ an incident angle and θₜ is a penetration angle (or angle of refraction). In other words, the travel of a light beam in media of different refractive indexes is determined by a maximum angle thereof according to Snell's law.

When a finger tip (F) smeared with sweat, oil (M) or the like contacts a fingerprint contact medium as illustrated in FIG. 3(a), there is no reflection of light beams from valleys (V) of a fingerprint while light beams are reflected from ridge lines (R), and fingerprint information is progressed along a third light path (\textcircled{3}). Furthermore, a light beam reflected from sweat or oil (M) progresses to a second light path (\textcircled{2}) according to Snell's law where the light beam having a larger angle than that of the second light path (\textcircled{2}) cannot progress. As a result, if only the fingerprint information progressing along the third light path (\textcircled{3}) is accepted, an afterimage caused by the sweat or oil can be removed.

In other words, as illustrated in FIG. 3(b), if there is no inclination at the prism (2), fingerprint information coming from ridge lines (R) of fingerprints and the afterimage (\textcircled{2}) coming from sweat or oil are overlapped to be incident on the lens (3) and the image sensor (4).

However, as shown in FIG. 3(c), if an inclination as large as an established angle (a) is given between a perpendicular line (PL) connecting to a corner (2-1) horizontally positioned from a surface (2a) contacting a fingerprint region of the prism (2) and an optical axis (OA) from the prism (2) to the lens (3) and the image sensor (4), the fingerprint information (\textcircled{3}) caused by ridges lines (R) is incident on the lens (3) while an afterimage (\textcircled{2}) caused by sweat or oil cannot be incident on the lens (3).

As a result, even though an afterimage caused by sweat or oil remain on the fingerprint contact surface, only the actual fingerprint information can be incident on the image sensor (4) via the lens (3) according to the principle thus described to thereby prevent an erroneous recognition that is generated by overlap of the afterimage with the actual fingerprints.

Korean Patent No. 453255 filed by the present applicant can be effective when only an internal light source of a fingerprint input device is used, i.e., when external lights are not incident via a fingerprint contact surface of the prism. However, when an external light source such as a flashlight or the like is incident on a fingerprint contact surface of a prism, there arises a problem in that a fingerprint afterimage of fingers generated by sweat, water or oil remaining on the fingerprint contact surface of the prism is incident on an image sensor via the prism and lens to result in occurrence of erroneous recognition of fingerprints.

For example, when light beams generated by a lighting at a place where a fingerprint input device is installed are incident on a fingerprint contact surface of a prism at an appropriate angle, or when an unlawful intruder artificially illuminates beam lights by way of a flashlight on the fingerprint contact surface of the prism at an appropriate angle, while a fingerprint afterimage of a normally verified user is vividly left on the fingerprint contact surface of the prism, the fingerprint afterimage of the normally verified user remaining on the fingerprint contact surface is incident on the image sensor to generate an erroneous recognition that a finger of the normally verified user is actually contacted on the fingerprint contact surface.

### SUMMARY OF THE INVENTION

The present invention is disclosed to solve the aforementioned drawback and it is an object of the invention to provide an optical fingerprint input device constructed to prevent an erroneous recognition caused by a fingerprint afterimage remaining on a fingerprint contact surface and an external light source.

In accordance with an object of the preferred embodiment of the present invention, there is provided an optical fingerprint input device including a triangular prism, a lens and an image sensor, wherein the device comprises: a light source for illuminating light beams in the direction of a surface contacting the fingerprint region out of three surfaces of the prism; and an identifying mark on a surface opposite to the lens out of two surfaces not contacting the fingerprint region of the prism.

Preferably, the identifying mark is printed on a film of a transparent light-penetrative material to be attached to a surface of the prism positioned opposite to the lens.

Preferably, the color of the light beams and that of the identifying mark on the film are complementary.

Preferably, the present invention further comprises an operational controller for analyzing images inputted to the image sensor to discriminate whether images of identifying mark are included on input images, and to determine related input images as afterimages when the images of the identifying mark are included as a result of discrimination, thereby generating an error code.

### BRIEF DESCRIPTION OF THE DRAWINGS

For a better understanding of the nature and objects of the present invention, reference should be made to the following detailed description with the accompanying drawings, in which:

FIG. 1 is a schematic diagram for illustrating an optical fingerprint input device according to the prior art;

FIG. 2 is a schematic diagram for illustrating a refracting phenomenon of light beams at a boundary surface of a medium;

FIGS. 3(a), 3(b) and 3(c) are schematic drawings for explaining a principle of how images of moisture, sweat, water or oil smeared on a fingerprint region of fingers are distinguished according to the inclination angle of the prism in FIG. 1; and

FIGS. 4 and 5 are schematic drawings for illustrating an optical fingerprint input device according to a preferred embodiment of the present invention.

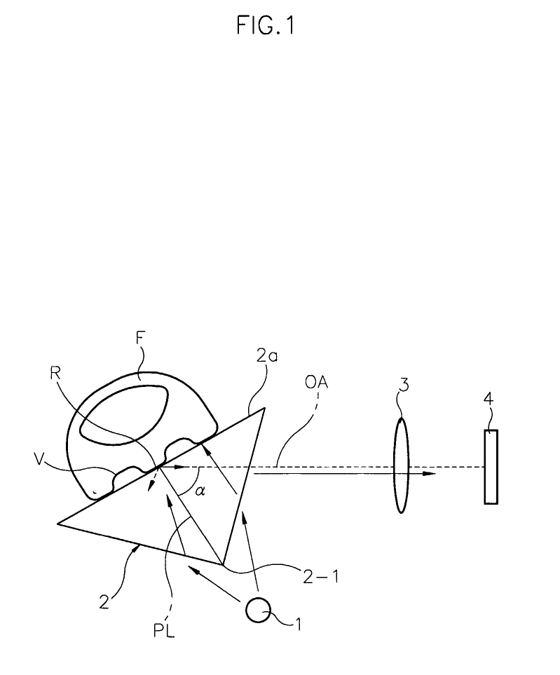

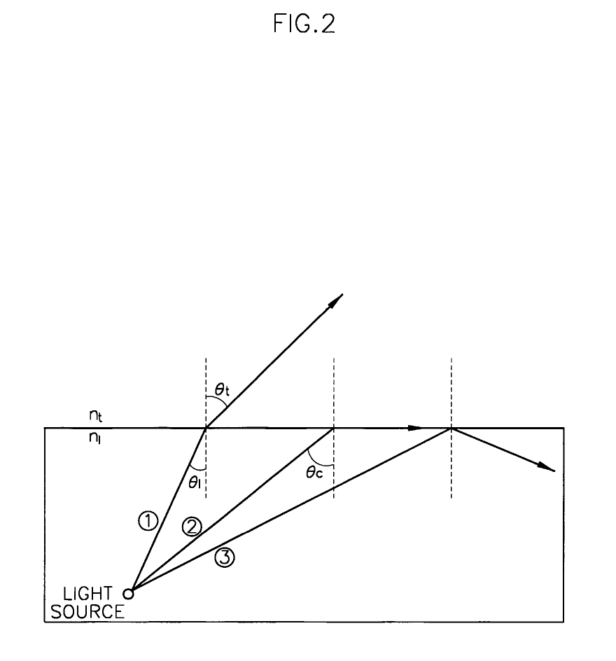

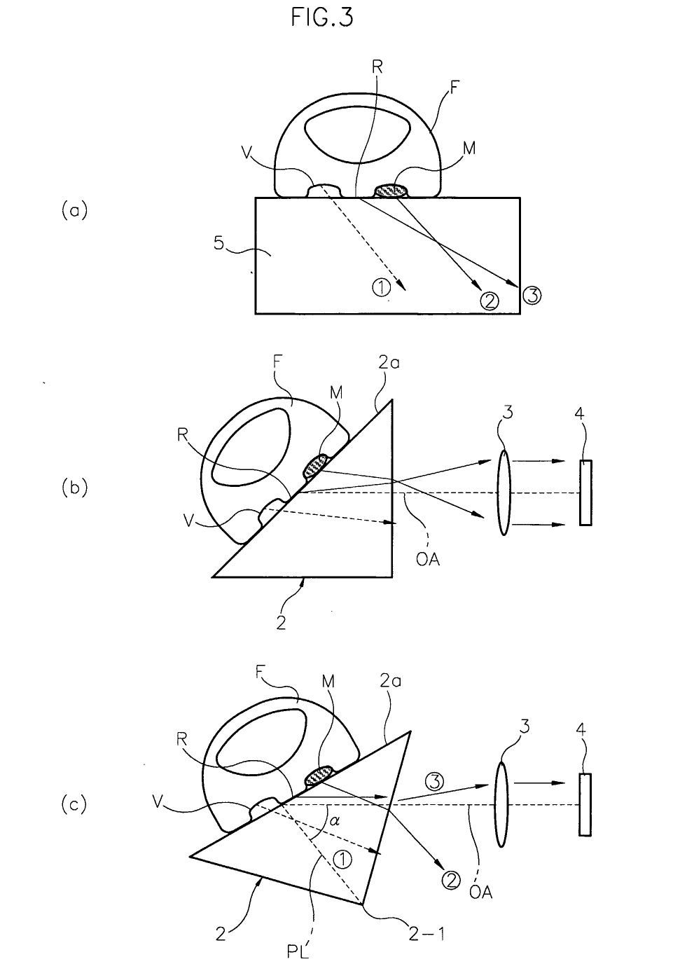

### DETAILED DESCRIPTION OF THE PREFERRED EMBODIMENT

The preferred embodiment of the present invention will now be described in detail with reference to the annexed drawings, where the present embodiment is not limiting the scope of the present invention but is given only as an illustrative purpose.

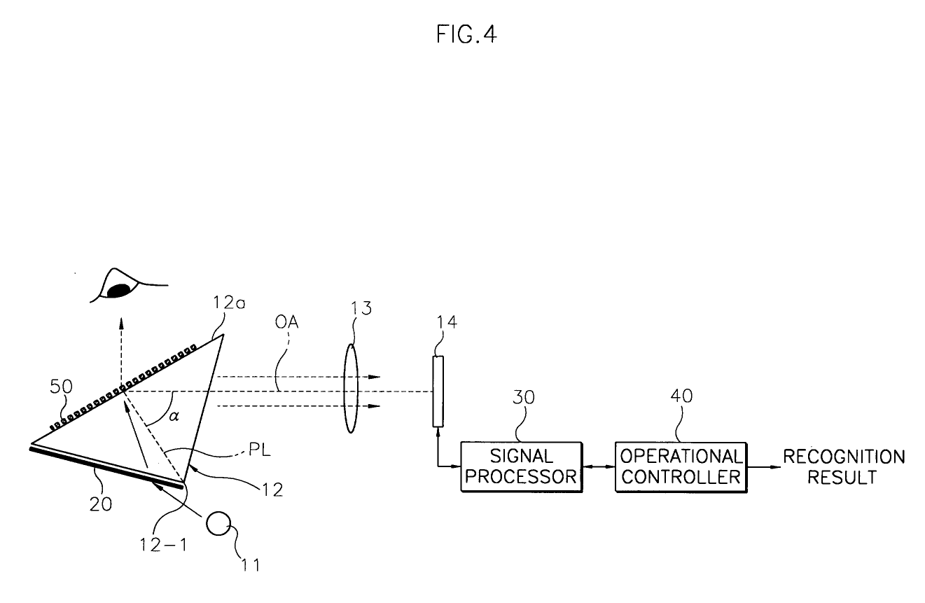

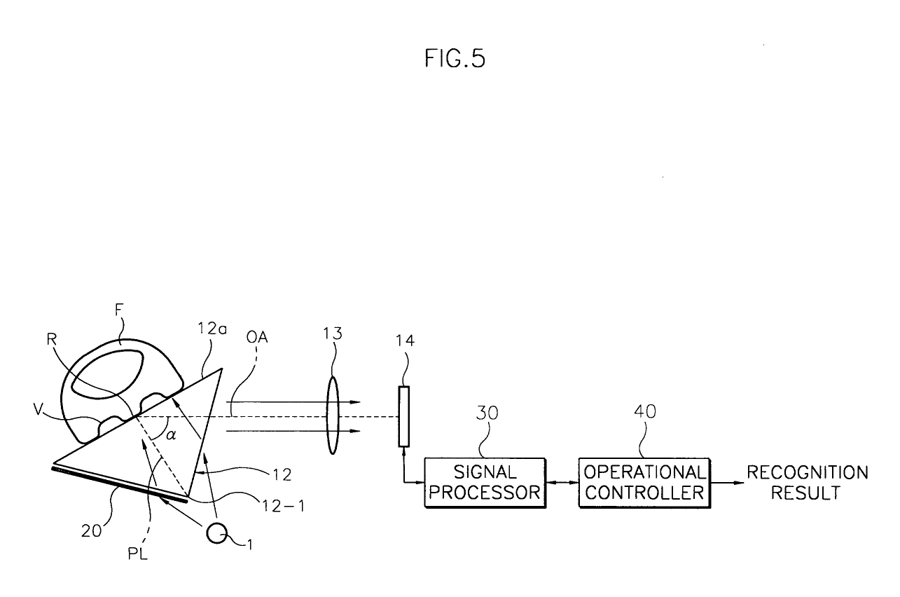

Referring to FIGS. 4 and 5, the optical fingerprint input device according to the embodiment of the present invention includes a light source (11), a prism (12), a lens (13), an image sensor (14), a film (20), a signal processor (30) and an operational controller (40).

The light source (11) is so arranged as to illuminate light beams to corners (12-1) vertically positioned relative to a surface (12a, hereinafter referred to as a fingerprint contact surface) where a fingerprint region is touched out of three surfaces of the prism (12).

The light source (11) is so controllably illuminated as a conventional light source intrinsically disposed in an optical fingerprint input device. In other words, the light source (11) is illuminated at all times or selectively by the operational controller (40) or by a separate light source control device, or illuminated by detection of finger touches according to a conventional touch detection means (a touch detection sensor or a proximity sensor) for detecting the finger touch relative to a fingerprint contact surface (12a) of the prism (12).

The prism (12) which is a triangular prism having three surfaces for being used for incidence, reflection and penetration of light beams (lateral surfaces are not used for optical purposes) receives light beams reflected and coming from a fingerprint region of a finger (F) touching the fingerprint contact surface (12a) and prompts the light beams to penetrate therethrough and to be refracted therefrom for transmission to the lens (13).

Preferably, the prism (12) is so configured that the incident angle (α) formed by a perpendicular line (PL) connected to the corner (12-1) vertically positioned relative to the fingerprint contact surface (12a) and an optical axis (OA) connecting the lens (13) and the image sensor (14) from the prism (12) is established at a predetermined degree obtainable by an experimental value for blocking an input of images of foreign objects such as water and oil smeared on the fingerprints of the finger (F) touching the fingerprint contact surface (12a).

This is because an erroneous recognition caused by an overlap of an afterimage with an actual fingerprint can be prevented by receiving only the actual fingerprint even if the fingerprint contact surface (12a) of the prism (12) is stained with sweat, water or oil when an internal light source (11) is used.

The lens (13) forms images of light beams penetrated and refracted from the prism (13), and the image sensor (14) receives the images formed by the light beams from the lens (13) and generates an electrical signal corresponding thereto.

The film (20) of light-penetrable material is attached to a surface opposite to the lens (13) out of two surfaces except for the fingerprint contact surface (12a) of the prism (12) and is attached thereon with a particular identifying mark such as a logo or the like.

Preferably, the color of the identifying mark on the film (20) is complementary to that of the light source (11) for minimizing the possibility of light beams (not the light beams coming from the outside of the fingerprint input device) generated by the internal light source (11) being reflected from the identifying mark region of the film (20) to be overlapped with the fingerprint images and incident on the image sensor (14).

For reference, when the color of the identifying mark on the film (20) and that of the light source (11) are complementary, the light absorption factor at the identifying mark region of the film (20) relative to the light beams from the light source (11) is high while reflection factor is minimized.

Furthermore, the identifying mark of the film (20) can be seen by a naked eye via the fingerprint contact surface (12a) of the prism (12) such that the mark may be used for advertisements or public information when an advertisement logo is used for the identifying mark of the film (20).

The signal processor (30) processes the signal outputted from the image sensor (14) to a form appropriate for image processing and inputs the signal to the operational controller (40).

The operational controller (40) performs the image processing according to the signal inputted from the image sensor (14) to the signal processor (30) to obtain and recognize the fingerprint images and outputs a result of the recognition. The operational controller (40) further analyzes the inputted fingerprint images to discriminate whether images of the identifying mark of the film (20) are included. As a result of the discrimination, if the images of the identifying mark of the film (20) are included, the operational controller (40) determines the recognized fingerprint as an afterimage and generates an error code to be outputted.

The operational merit of the present invention thus constructed will now be described.

First, when a finger (F) is not touched on the fingerprint contact surface (12a) of the prism (12) while a fingerprint afterimage (50) caused by water, sweat or oil remains on the surface (12a), most of the light beams illuminated from the light source (11) pass through the outside via the fingerprint contact surface (12a) of the prism (12) while part of light beams reflected by the fingerprint afterimages (50) are not formed with images on the lens (13) due to small amount of the reflected light beams and the incident angle (α) of the prism (12), as shown in FIG. 4.

However, when light beams from an external light source (for example, flashlight or an illuminating light at a place where a fingerprint input device is installed) are incident at an appropriate angle on the fingerprint contact surface (12a) of the prism (12), the fingerprint afterimage (50) is incident on the image sensor (14) via the lens (13).

Part of the light beams incident on the fingerprint contact surface (12a) of the prism (12) from the external light source are reflected on the identifying mark region of the film (20) to advance along the optical axis (OA) such that the images of the identifying mark on the film (20) are incident on the image sensor (14) via the lens (13), being overlapped with the fingerprint afterimage (50).

As a result, the operational controller (40) conducts the image processing according to the signal inputted from the image sensor (14) to the signal processor (30) to obtain and recognize the fingerprint images. The operational controller (40) further discriminates whether the images of the identifying mark are included in the recognized fingerprint images, and if the images of the identifying mark are included, the operational controller (40) refuses to verify the fingerprint to generate an error code.

Meanwhile, when a finger (F) touches the fingerprint contact surface (12a) of the prism (12), the external light source is blocked by the finger (F), and as illustrated in FIG. 5, only the light beams illuminated from the internal light source (11) and reflected from the ridge lines (R) of the fingerprint region of the finger (F) are incident on the image sensor (14) via the lens (13) to thereby obtain only the images of the fingerprint of the finger (F) via the operational controller (40).

The foregoing description of the preferred embodiment of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto, and their equivalents.

Particularly, in the preferred embodiment of the present invention, although only a case of attaching a film on one surface of the prism for mark identification is explained, it is not to limit the invention and other mark identifications may be possible by directly printing or coating on one surface of the prism, or a method of relief engraving, or a method of depressed engraving.

As apparent from the foregoing, there is an advantage in the optical fingerprint input device thus described according to the embodiment of the present invention in that a mark identification is conducted by light beams incident on one surface of a prism and then reflected on a lens such that erroneous recognition caused by a fingerprint afterimage of water, sweat or oil remaining on the fingerprint contact surface of the prism can be prevented to improve the security of the device.

There is another advantage in that a visual advertisement or public information effect can be additionally obtained when a mark identification logo for advertisement is attached on one surface of the prism.

1. An optical fingerprint input device including a triangular prism, a lens and an image sensor, wherein the device comprises:
a light source for illuminating light in the direction of a surface contacting the fingerprint region out of three surfaces of a prism; and
an identifying mark on a surface opposite to the lens out of two surfaces not contacting the fingerprint region of the prism.

2. The device as defined in claim 1, wherein said identifying mark is printed on a film of a transparent light-penetrative material attached to a surface of the prism positioned opposite to the lens.

3. The device as defined in claim 1, wherein the color of the light beams and that of said identifying mark on the film are complementary.

4. The device as defined in claim 1, further comprising an operational controller for analyzing images inputted to the image sensor to discriminate whether images of an identifying mark are included on input images, and to determine related input images as afterimages when the images of the identifying mark are included as a result of discrimination, thereby generating an error code.

5. The device as defined in claim 1, wherein the prism so configured that an incident angle formed by a perpendicular line (PL) connected to a corner vertically positioned relative to the fingerprint contact surface and an optical axis (OA) connecting the lens and the image sensor from the prism is established at a predetermined degree obtainable by an experimental value for blocking an input of images of foreign objects such as water and oil smeared on the fingerprints of the finger touching the fingerprint contact surface.

6. The device as defined in claim 2, further comprising an operational controller for analyzing images inputted to the image sensor to discriminate whether images of an identifying mark are included on input images, and to determine related input images as afterimages when the images of the identifying mark are included as a result of discrimination, thereby generating an error code.

7. The device as defined in claim 2, wherein the prism so configured that an incident angle formed by a perpendicular line (PL) connected to a corner vertically positioned relative to the fingerprint contact surface and an optical axis (OA) connecting the lens and the image sensor from the prism is established at a predetermined degree obtainable by an experimental value for blocking an input of images of foreign objects such as water and oil smeared on the fingerprints of the finger touching the fingerprint contact surface.
